(19) United States
(12) Patent Application Publication
(10) Pub. No.: US 2021/0138813 A1
(43) Pub. Date: May 13, 2021

(54) RIBBON CARTRIDGE

(71) Applicant: SEIKO EPSON CORPORATION, Tokyo (JP)

(72) Inventors: Akio ISHIMOTO, Shiojiri-shi (JP); Taishi SASAKI, Matsumoto-shi (JP)

(73) Assignee: Seiko Epson Corporation, Tokyo (JP)

(21) Appl. No.: 17/042,268

(22) PCT Filed: Mar. 1, 2019
(86) PCT No.: PCT/JP2019/008054

§ 371 Date: Sep. 28, 2020

(30) Foreign Application Priority Data
Mar. 29, 2018 (JP) 2018-063684

(51) Int. Cl. B41J 32/00; B41J 2/325

(52) U.S. Cl. CPC B41J 32/00; B41J 2/325

(57) ABSTRACT

A ribbon cartridge can be properly attached to and detached from a cartridge mounting portion. The ribbon cartridge includes a paying-out core around which an ink ribbon is wound, a cartridge case having a ribbon core accommodating portion accommodating the paying-out core and a winding core, in which the ribbon core accommodating portion is near one side of the cartridge case in a longitudinal direction, and in the cartridge case, a head insertion portion into which a head cover is inserted is on the other side of the cartridge case in the longitudinal direction, which is an opposite side to the one side, and a grip portion for gripping the cartridge case is near the one side when the ribbon cartridge is mounted in the cartridge mounting portion.

### TECHNICAL FIELD

The present invention relates to a ribbon cartridge accommodating an ink ribbon.

### BACKGROUND ART

In the related art, as disclosed in PTL 1, a printing device which includes a tape printing portion including a cassette mounting portion in which a tape cassette is mounted and a tube printing portion including a ribbon mounting portion in which a ribbon cassette for performing printing on a tube is mounted, and the ribbon cassette to be mounted in the printing device are known.

### CITATION LIST

### Patent Literature

PTL 1: JP-A-2017-024324

### SUMMARY OF INVENTION

### Technical Problem

Since the printing device disclosed in PTL 1 includes print heads in the tape printing portion and the tube printing portion, respectively, the printing device becomes large and the manufacturing cost also increases. In the printing device including a first cartridge mounting portion in which a first ribbon cartridge is mounted and a second cartridge mounting portion in which a second ribbon cartridge having a ribbon accommodation capacity larger than that of the first ribbon cartridge is mounted, the inventor of the present invention has conceived to commonize a part of the first cartridge mounting portion, a part of the second cartridge mounting portion, and the print head. However, in such a printing device, when a first winding shaft inserted into a first winding core accommodated in the first ribbon cartridge is provided in an overlapping region of the first cartridge mounting portion and the second cartridge mounting portion, it is necessary to prevent the first winding shaft from interfering with the second ribbon cartridge when the second ribbon cartridge is mounted. Further, it is necessary to provide a space in the second ribbon cartridge for increasing the ribbon accommodation capacity, and the weight balance of the second ribbon cartridge may be biased to one side. As a result, when the second ribbon cartridge is attached to or detached from the second cartridge mounting portion, it may not be possible to properly attach or detach the second ribbon cartridge.

An object of the present invention is to provide a ribbon cartridge that can be properly attached to and detached from a cartridge mounting portion.

### Solution to Problem

A ribbon cartridge according to the present invention is a ribbon cartridge that is a second ribbon cartridge to be mounted in a printing device including a first cartridge mounting portion in which a first ribbon cartridge accommodating a first winding core around which a first ink ribbon is wound is mounted, a second cartridge mounting portion in which the second ribbon cartridge accommodating a second winding core around which a second ink ribbon is wound is mounted, a first winding shaft which is provided in an overlapping region of the first cartridge mounting portion and the second cartridge mounting portion and is inserted into the first winding core when the first ribbon cartridge is mounted in the first cartridge mounting portion, and a second winding shaft, which is provided in a second non-overlapping region out of the overlapping region in the second cartridge mounting portion and is inserted into the second winding core when the second ribbon cartridge is mounted in the second cartridge mounting portion, the ribbon cartridge including: a second paying-out core around which the second ink ribbon is wound; and a second cartridge case having a second ribbon core accommodating portion accommodating the second paying-out core and the second winding core, in which a print head and a head cover that covers the print head are provided in the overlapping region, the second ribbon core accommodating portion is provided near one side of the second cartridge case in a longitudinal direction, and in the second cartridge case, a head insertion portion into which the head cover is inserted is provided on the other side of the second cartridge case in the longitudinal direction, which is an opposite side to the one side and a grip portion for gripping the second cartridge case is provided near the one side when the second ribbon cartridge is mounted in the second cartridge mounting portion.

### BRIEF DESCRIPTION OF DRAWINGS

FIG. 1 is a perspective view of a tape printing device in which a ribbon cartridge and a tape guide according to an embodiment of the present invention are mounted.

FIG. 2 is a view of the tape printing device in which the ribbon cartridge and the tape guide are mounted, as seen from the front side in the mounting direction.

FIG. 3 is a view of the tape printing device with a tape cartridge mounted, as seen from the front side in the mounting direction.

FIG. 4 is a view of the tape printing device as seen from the front side in the mounting direction.

FIG. 5 is a perspective view of the ribbon cartridge.

FIG. 6 is a view of the ribbon cartridge as seen from the front side in the mounting direction.

FIG. 7 is a view of the ribbon cartridge as seen from the −Y side.

FIG. 8 is a view of the ribbon cartridge as seen from the +Y side.

FIG. 9 is a perspective view of the ribbon cartridge with a front side case removed.

FIG. 10 is a view of the ribbon cartridge with the front side case removed, as seen from the front side in the mounting direction.

FIG. 11 is a view of a back side case as seen from the front side in the mounting direction.

FIG. 12 is a view of a front side case of a ribbon cartridge according to a modification example as seen from the front side in the mounting direction.

FIG. 13 is a view of a front side case of a ribbon cartridge according to another modification example as seen from the front side in the mounting direction.

### DESCRIPTION OF EMBODIMENTS

Hereinafter, with reference to the accompanying drawings, a ribbon cartridge 200, which is an embodiment of a “second ribbon cartridge” of the present invention, will be described together with a tape printing device P in which the ribbon cartridge 200 is mounted. The tape printing device P is an example of the “printing device” of the present invention. In the following drawings, an XYZ orthogonal coordinate system is shown in order to clarify the arrangement relationship of each portion, but it goes without saying that it does not limit the present invention in any way.

### [Tape Printing Device]

The tape printing device P will be described with reference to FIGS. 1 to 4. A tape cartridge 100, the ribbon cartridge 200, and a tape guide 400 are detachably mounted in the tape printing device P. A first tape 111 and a first ink ribbon 113 are accommodated in the tape cartridge 100. The tape cartridge 100 is an example of the “first ribbon cartridge” of the present invention. A second ink ribbon 213 is accommodated in the ribbon cartridge 200. The ribbon cartridge 200 is an example of the “second ribbon cartridge” of the present invention. Further, the tape printing device P is provided with a tape introduction port 11 for introducing a second tape 500 from outside the tape printing device P. The tape guide 400 guides the second tape 500 introduced from the tape introduction port 11. The tape printing device P can execute first tape printing for performing printing on the first tape 111 with the tape cartridge 100 mounted as shown in FIG. 3 and second tape printing for performing printing on the second tape 500 with the ribbon cartridge 200 and the tape guide 400 mounted as shown in FIGS. 1 and 2.

The tape printing device P includes a device case 1, a mounting portion cover 3, a first cartridge mounting portion 5, and a second cartridge mounting portion 7. The device case 1 is formed in a substantially rectangular parallelepiped shape. The device case 1 is provided with a tape discharge port 9 on the −X side surface and a tape introduction port 11 on the +X side surface. The printed first tape 111 or the printed second tape 500 is discharged from the tape discharge port 9. The second tape 500 is introduced into the tape introduction port 11 from outside the tape printing device P.

The mounting portion cover 3 is provided on the device case 1 so as to be rotatable around the +Y side end portion. The mounting portion cover 3 opens and closes the first cartridge mounting portion 5 and the second cartridge mounting portion 7. The mounting portion cover 3 is locked in a closed state by a cover lock mechanism (not shown). Then, when a cover open button (not shown) is pressed, the cover lock mechanism is unlocked and the mounting portion cover 3 is opened.

A first pressing projection 13, a second pressing projection 15, and a third pressing projection 17 are provided on the inner surface of the mounting portion cover 3 so as to project. When the mounting portion cover 3 is closed with the ribbon cartridge 200 mounted in the second cartridge mounting portion 7, the first pressing projection 13, the second pressing projection 15, and the third pressing projection 17 abut on the ribbon cartridge 200. Therefore, the ribbon cartridge 200 is mounted in a state of being pressed by the first pressing projection 13, the second pressing projection 15, and the third pressing projection 17.

Although not shown, a keyboard and a display are provided on the outer surface of the mounting portion cover 3. The keyboard receives print information such as a character string and an input operation of various instructions such as print execution. The display displays various information in addition to the print information input from the keyboard. When the keyboard receives a print execution input operation, the tape printing device P executes print processing based on the print information input from the keyboard. The tape printing device P may be configured to include input display means such as a touch panel display instead of the keyboard and the display. Further, the tape printing device P may be configured to execute print processing based on print data and commands received from an external device such as a personal computer or a smartphone. The keyboard and the display may or may not be provided when connecting to these external devices.

The first cartridge mounting portion 5 and the second cartridge mounting portion 7 are provided on the +Z side surface of the device case 1. The tape cartridge 100 is detachably mounted in the first cartridge mounting portion 5. The ribbon cartridge 200 is detachably mounted in the second cartridge mounting portion 7. The first cartridge mounting portion 5 and the second cartridge mounting portion 7 are formed in a concave shape in which the +Z side is opened. Therefore, the tape cartridge 100 and the ribbon cartridge 200 are mounted in the first cartridge mounting portion 5 and the second cartridge mounting portion 7, respectively, from the +Z side. Hereinafter, the mounting directions of the tape cartridge 100 and the ribbon cartridge 200 are simply referred to as “mounting directions”. Further, the front side in the mounting direction means the +Z side, and the back side in the mounting direction means the −Z side.

As shown in FIG. 4, the −Y side portion of the first cartridge mounting portion 5 and the −X side portion of the second cartridge mounting portion 7 are commonized. Here, the portion where the first cartridge mounting portion 5 and the second cartridge mounting portion 7 overlap is referred to as an overlapping region 21. Further, a portion of the first cartridge mounting portion 5 which is out of the overlapping region 21 is referred to as a first non-overlapping region 23, and a portion of the second cartridge mounting portion 7 which is out of the overlapping region 21 is referred to as a second non-overlapping region 25. The first non-overlapping region 23 functions as a guide mounting portion to which the tape guide 400 is detachably mounted. In this way, since the first cartridge mounting portion 5 and the second cartridge mounting portion 7 are partly commonized, the tape printing device P can be downsized as compared with the structure in which the first cartridge mounting portion 5 and the second cartridge mounting portion 7 are separately provided.

As shown in FIG. 3, at the time of the first tape printing, the tape cartridge 100 is mounted in the first cartridge mounting portion 5. In this state, the tape printing device P performs printing on the first tape 111 while feeding the first tape 111 and the first ink ribbon 113 accommodated in the tape cartridge 100.

As shown in FIGS. 1 and 2, at the time of the second tape printing, the tape guide 400 is mounted in the first cartridge mounting portion 5, and the ribbon cartridge 200 is mounted in the second cartridge mounting portion 7. In this state, the tape printing device P performs printing on the second tape 500 while feeding the second tape 500 introduced from the tape introduction port 11 and the second ink ribbon 213 accommodated in the ribbon cartridge 200.

The second tape 500 is provided as, for example, a tape roll wound in a roll shape. The length of the second tape 500 in the unused tape roll and the length of the second ink ribbon 213 accommodated in the ribbon cartridge 200 are not particularly limited. However, in the present embodiment, they are longer than the length of the first tape 111 and the length of the first ink ribbon 113 accommodated in the unused tape cartridge 100. Therefore, for example, when a large number of labels are created at one time, the second tape printing is executed.

### [Tape Cartridge]

The tape cartridge 100 will be described with reference to FIG. 3. The tape cartridge 100 includes a tape core 101, a first platen roller 103, a first paying-out core 105, a first winding core 107, and a first cartridge case 109 that rotatably accommodates these. A first tape 111 is wound around the tape core 101. A first ink ribbon 113 is wound around the first paying-out core 105 with the surface coated with ink inside. There are a plurality of types of the first cartridge case 109, which have different thicknesses, that is, dimensions in the mounting direction, depending on the widths of the first tape 111 and the first ink ribbon 113 accommodated therein.

The first cartridge case 109 is formed in a substantially “L” shape when seen from the front side in the mounting direction. A tape core accommodating portion 115 is provided at a substantially half portion on the +Y side of the first cartridge case 109. The tape core 101 is rotatably accommodated in the tape core accommodating portion 115.

Of the approximately −Y side half portion of the first cartridge case 109, the first ribbon core accommodating portion 117 is provided on the +X side, and the first head insertion portion (not shown) is provided on the −X side. The first paying-out core 105 and the first winding core 107 are rotatably accommodated in the first ribbon core accommodating portion 117. The first head insertion portion, the first paying-out core 105, and the first winding core 107 are respectively provided at positions corresponding to a thermal head 27, a first paying-out shaft 29, and a first winding shaft 31 (see FIG. 4) provided in the overlapping region 21. The thermal head 27 is inserted into the first head insertion portion when the tape cartridge 100 is mounted in the first cartridge mounting portion 5. A first ribbon exposing portion (not shown) for exposing the first ink ribbon 113 is provided at the peripheral edge portion of the first head insertion portion. The first ink ribbon 113 fed from the first paying-out core 105 passes through the first ribbon exposing portion and is wound around the first winding core 107.

A tape delivery port 123 is provided on the −X side surface of the first cartridge case 109. The printed first tape 111 is sent out of the first cartridge case 109 from the tape delivery port 123. Although not shown in the drawings, a first hook engaging portion is provided on the +X side surface and the −X side surface of the first cartridge case 109.

### [Outline of Ribbon Cartridge]

An outline of the ribbon cartridge 200 will be described with reference to FIG. 2. The ribbon cartridge 200 includes a second paying-out core 205, a second winding core 207, and a second cartridge case 209 that rotatably accommodates these. A second ink ribbon 213 is wound around the second paying-out core 205 with the surface coated with the ink inside. Hereinafter, the surface of the second ink ribbon 213 coated with ink is referred to as an ink surface 213a. There are a plurality of types of the second cartridge case 209 having different thicknesses depending on the width of the accommodated second ink ribbon 213.

The second cartridge case 209 is formed in a substantially rectangular shape that is long in the X direction when viewed from the front side in the mounting direction. A second ribbon core accommodating portion 217 is provided on the +X side of the second cartridge case 209, and a second head insertion portion 219 (see FIG. 5) is provided on the −X side. The second paying-out core 205 and the second winding core 207 are rotatably accommodated in the second ribbon core accommodating portion 217. The second head insertion portion 219, the second paying-out core 205, and the second winding core 207 are respectively provided at positions corresponding to the thermal head 27 provided in the overlapping region 21 and a second paying-out shaft 45 (See FIG. 4) and a second winding shaft 47 provided in the second non-overlapping region 25. The second ink ribbon 213 is wound around the second paying-out core 205, and the second ink ribbon 213 is wound around the second winding core 207. Therefore, the center of gravity of the ribbon cartridge 200 is located closer to the second ribbon core accommodating portion 217 that accommodates the second paying-out core 205 and the second winding core 207, that is, closer to the +X side in the longitudinal axis of the ribbon cartridge 200. Specifically, the center of gravity of the ribbon cartridge 200 at the initial stage of use is located in the vicinity of an intermediate position between the second paying-out core 205 and a paying-out side cylinder portion 277 (see FIG. 6) described later. This center of gravity gradually moves to the +X side where the second winding core 207 is located as the second ink ribbon 213 is used.

The thermal head 27 is inserted into the second head insertion portion 219 when the ribbon cartridge 200 is mounted in the second cartridge mounting portion 7. The thermal head 27 is an example of the “print head” of the present invention. A second ribbon exposing portion 221 (see FIG. 5) for exposing the second ink ribbon 213 is provided at the peripheral edge portion of the second head insertion portion 219. The second ink ribbon 213 fed from the second paying-out core 205 passes through the second ribbon exposing portion 221 and is wound around the second winding core 207. Further, a second hook engaging portion 225 is provided on the −Y side surface, the +X side surface, and the +Y side surface of the second cartridge case 209 (see FIGS. 5 and 7 to 9).

### [Tape Guide]

The tape guide 400 will be described with reference to FIG. 2. The tape guide 400 includes a roller support portion 401 and a second platen roller 403. The roller support portion 401 rotatably supports the second platen roller 403. There are a plurality of types of the tape guide 400 having different thicknesses depending on the width of the second tape 500 to be guided.

### [Cartridge Mounting Portion]

The first cartridge mounting portion 5 and the second cartridge mounting portion 7 will be described with reference to FIG. 4. As described above, the first cartridge mounting portion 5 and the second cartridge mounting portion 7 can be divided into the overlapping region 21, the first non-overlapping region 23, and the second non-overlapping region 25.

The thermal head 27, the first paying-out shaft 29, and the first winding shaft 31 are provided on the bottom surface of the overlapping region 21, that is, the surface on the back side of the overlapping region 21 in the mounting direction so as to project toward the front side in the mounting direction. The thermal head 27 has a larger amount of projection toward the front side in the mounting direction than the first paying-out shaft 29 and the first winding shaft 31. Although not shown, a cutter is provided between the thermal head 27 and the tape discharge port 9. The cutter cuts the first tape 111 or the second tape 500 at a position between the thermal head 27 and the tape discharge port 9.

The thermal head 27 is covered by a head cover 33 that projects toward the front side in the mounting direction, except for a part on the +Y side and the −Z side. When the tape cartridge 100 is mounted in the first cartridge mounting portion 5, the head cover 33 is inserted into the first head insertion portion. Further, when the ribbon cartridge 200 is mounted in the second cartridge mounting portion 7, the head cover 33 is inserted into the second head insertion portion 219.

A first paying-out rotation member 35 is rotatably provided on the first paying-out shaft 29. The first paying-out shaft 29 is inserted into the first paying-out core 105 when the tape cartridge 100 is mounted in the first cartridge mounting portion 5, and the first paying-out rotation member 35 is engaged with the first paying-out core 105. Further, the first paying-out shaft 29 is inserted into the paying-out side cylinder portion 277 (see FIG. 9) provided in the ribbon cartridge 200 when the ribbon cartridge 200 is mounted in the second cartridge mounting portion 7.

A first winding rotation member 37 is rotatably provided on the first winding shaft 31. The first winding shaft 31 is inserted into the first winding core 107 when the tape cartridge 100 is mounted in the first cartridge mounting portion 5, and the first winding rotation member 37 is engaged with the first winding core 107. Further, the first winding shaft 31 is inserted into the winding side cylinder portion 279 (see FIG. 9) provided in the ribbon cartridge 200 when the ribbon cartridge 200 is mounted in the second cartridge mounting portion 7.

A platen shaft 39 and two first hooks 41 are provided on the bottom surface of the first non-overlapping region 23 so as to project toward the front side in the mounting direction.

A platen rotation member 43 is rotatably provided on the platen shaft 39. The platen shaft 39 is inserted into the first platen roller 103 when the tape cartridge 100 is mounted in the first cartridge mounting portion 5, and the platen rotation member 43 is engaged with the first platen roller 103. Further, the platen shaft 39 is inserted into the second platen roller 403 when the tape guide 400 is mounted in the first non-overlapping region 23, and the platen rotation member 43 is engaged with the second platen roller 403.

The two first hooks 41 are provided at both end portions of the first non-overlapping region 23 in the X direction and are engaged with the first hook engaging portion provided in the first cartridge case 109 when the tape cartridge 100 is mounted in the first cartridge mounting portion 5. As a result, the tape cartridge 100 is prevented from being mounted in a state of floating from the bottom surface of the first cartridge mounting portion 5.

A second paying-out shaft 45, the second winding shaft 47, three second hooks 49, and a receiving portion 51 are provided on the bottom surface of the second non-overlapping region 25 so as to project toward the front side in the mounting direction. Further, the substrate connecting portion 53 is fixed to the −Y side inner peripheral surface of the second non-overlapping region 25.

A second paying-out rotation member 55 is rotatably provided on the second paying-out shaft 45. The second paying-out shaft 45 is inserted into the second paying-out core 205 when the ribbon cartridge 200 is mounted in the second cartridge mounting portion 7, and the second paying-out rotation member 55 is engaged with the second paying-out core 205.

A second winding rotation member 57 is rotatably provided on the second winding shaft 47. The second winding shaft 47 is inserted into the second winding core 207 when the ribbon cartridge 200 is mounted in the second cartridge mounting portion 7, and the second winding rotation member 57 is engaged with the second winding core 207.

The three second hooks 49 are provided so as to surround the second paying-out shaft 45 and the second winding shaft 47. The second hook 49 is engaged with the second hook engaging portion 225 provided on the second cartridge case 209 when the ribbon cartridge 200 is mounted in the second cartridge mounting portion 7.

The receiving portion 51 is located and provided at a +X side and −Y side corner of the second cartridge mounting portion 7. The receiving portion 51 is inserted into a receiving insertion hole 297 (see FIG. 10) provided in the second cartridge case 209 when the ribbon cartridge 200 is mounted in the second cartridge mounting portion 7.

The substrate connecting portion 53 is provided at the +X side end portion in the −Y side inner peripheral surface of the second cartridge mounting portion 7. That is, the substrate connecting portion 53 is provided on the −Y side of the receiving portion 51. The substrate connecting portion 53 is connected to a control circuit (not shown) included in the tape printing device P. The substrate connecting portion 53 is connected to a circuit substrate 311 (see FIG. 5) included in the ribbon cartridge 200 when the ribbon cartridge 200 is mounted in the second cartridge mounting portion 7. Thereby, the control circuit can read various information stored in the circuit substrate 311 and can write various information in the circuit substrate 311.

In the tape printing device P configured as above, when the tape cartridge 100 is mounted in the first cartridge mounting portion 5 for the first tape printing, the platen rotation member 43, the first paying-out rotation member 35, and the first The winding rotation member 37 are engaged with the first platen roller 103, the first paying-out core 105, and the first winding core 107, respectively. Then, when the mounting portion cover 3 is closed, the head moving mechanism (not shown) moves the thermal head 27 toward the platen shaft 39. As a result, the first ink ribbon 113 exposed at the first ribbon exposing portion is nipped between the thermal head 27 and the first platen roller 103 together with the first tape 111.

When the feed motor (not shown) rotates in the forward direction in this state, the driving force of the feed motor is transmitted to the platen rotation member 43, the first winding rotation member 37, and the second winding rotation member 57. Then, the first platen roller 103 engaged with the platen rotation member 43 rotates clockwise when viewed from the front side in the mounting direction, and the first winding core 107 engaged with the first winding rotation member 37 rotates counterclockwise when viewed from the front side in the mounting direction. As a result, the first tape 111 fed from the tape core 101 is fed toward the tape discharge port 9, and the first ink ribbon 113 fed from the first paying-out core 105 is wound around the first winding core 107. At this time, the second winding rotation member 57 is in the idle state.

When the feed motor rotates in the return direction opposite to the forward direction, the driving force of the feed motor is transmitted to the platen rotation member 43, the first paying-out rotation member 35, and the second paying-out rotation member 55. Then, the first platen roller 103 engaged with the platen rotation member 43 rotates counterclockwise when viewed from the front side in the mounting direction, and the first paying-out core 105 engaged with the first paying-out rotation member 35 rotates counterclockwise when viewed from the front side in the mounting direction. As a result, the first tape 111 fed from the tape core 101 is fed toward the tape core 101, and the first ink ribbon 113 fed from the first paying-out core 105 is rewound onto the first paying-out core 105. At this time, the second paying-out rotation member 55 is in the idle state.

At the time of the first tape printing, the tape printing device P feeds the first tape 111 toward the tape discharge port 9 by rotating the feed motor in the forward direction and performs printing on the first tape 111 by heating the thermal head 27 while winding the first ink ribbon 113 onto the first winding core 107. After the printing is completed, the tape printing device P causes the cutter to perform a cutting operation to cut off the printed portion of the first tape 111. After that, the tape printing device P rotates the feed motor in the return direction to feed the first tape 111 toward the tape core 101 and rewinds the first ink ribbon 113 onto the first paying-out core 105. As a result, the first tape 111 is pulled back until the front end of the first tape 111 comes close to the nipping position between the thermal head 27 and the first platen roller 103, that is, near the printing position. For this reason, in the first tape 111 to be printed next, it is possible to shorten the blank space generated at the front of the first tape 111 in the length direction due to the distance between the thermal head 27 and the cutter.

On the other hand, when the ribbon cartridge 200 is mounted in the second cartridge mounting portion 7 for the second tape printing, the second paying-out rotation member 55 and the second winding rotation member 57 are engaged with the second paying-out core 205 and the second winding core 207, respectively. Further, when the tape guide 400 is mounted in the first non-overlapping region 23, the platen rotation member 43 is engaged with the second platen roller 403. The second tape 500 introduced from the tape introduction port 11 is set in the tape guide 400. Then, when the mounting portion cover 3 is closed, the thermal head 27 moves toward the platen shaft 39. As a result, the second ink ribbon 213 exposed at the second ribbon exposing portion 221 is nipped between the thermal head 27 and the second platen roller 403 together with the second tape 500.

When the feed motor rotates in the forward direction in this state, the driving force of the feed motor is transmitted to the platen rotation member 43, the first winding rotation member 37, and the second winding rotation member 57. Then, the second platen roller 403 engaged with the platen rotation member 43 rotates clockwise when viewed from the front side in the mounting direction, and the second winding core 207 engaged with the second winding rotation member 57 rotates counterclockwise when viewed from the front side in the mounting direction. As a result, the second tape 500 introduced from the tape introduction port 11 is fed toward the tape discharge port 9, and the second ink ribbon 213 fed from the second paying-out core 205 is wound around the second winding core 207. At this time, the first winding rotation member 37 is in the idle state.

When the feed motor rotates in the return direction, the driving force of the feed motor is transmitted to the platen rotation member 43, the first paying-out rotation member 35, and the second paying-out rotation member 55. Then, the second platen roller 403 engaged with the platen rotation member 43 rotates counterclockwise when viewed from the front side in the mounting direction, and the second paying-out core 205 engaged with the second paying-out rotation member 55 rotates counterclockwise when viewed from the front side in the mounting direction. As a result, the second tape 500 introduced from the tape introduction port 11 is fed toward the tape introduction port 11, and the second ink ribbon 213 fed from the second paying-out core 205 is rewound onto the second paying-out core 205. At this time, the first paying-out rotation member 35 is in the idle state.

At the time of the second tape printing, as at the time of the first tape printing, the tape printing device P feeds the second tape 500 toward the tape discharge port 9 by rotating the feed motor in the forward direction and performs printing on the second tape 500 by heating the thermal head 27 while winding the second ink ribbon 213 onto the second winding core 207. After the printing is completed, the tape printing device P causes the cutter to perform a cutting operation to cut off the printed portion of the second tape 500. After that, the tape printing device P rotates the feed motor in the return direction to feed the second tape 500 toward the tape introduction port 11 and rewinds the second ink ribbon 213 onto the second paying-out core 205. As a result, the second tape 500 is pulled back until the front end of the second tape 500 comes close to the nipping position between the thermal head 27 and the second platen roller 403, that is, near the printing position. For this reason, in the second tape 500 to be printed next, it is possible to shorten the blank space generated at the front of the second tape 500 in the length direction due to the distance between the thermal head 27 and the cutter.

### [Details of Ribbon Cartridge]

The ribbon cartridge 200 will be further described with reference to FIGS. 5 to 11. As shown in FIG. 5, the second cartridge case 209 includes a front side case 227 and a back side case 229. The front side case 227 is on the front side in the mounting direction when the ribbon cartridge 200 is mounted in the second cartridge mounting portion 7. The back side case 229 becomes the back side in the mounting direction when the ribbon cartridge 200 is mounted in the second cartridge mounting portion 7. The front side case 227 is a resin molded product having a light-transmitting property, and the back side case 229 is a resin molded product having no light-transmitting property. However, the material and the manufacturing method of the front side case 227 and the back side case 229 are not limited to this.

As shown in FIGS. 5 and 6, the front side case 227 includes a front side wall portion 233 and a first peripheral wall portion 235. The front side wall portion 233 is on the front side in the mounting direction when the ribbon cartridge 200 is mounted in the second cartridge mounting portion 7. The front side wall portion 233 is provided with a front side paying-out boss 237 and a front side winding opening 239. The front side paying-out boss 237 and the front side winding opening 239 are provided in the second ribbon core accommodating portion 217. The front side paying-out boss 237 and the front side winding opening 239 are respectively provided at positions corresponding to the second paying-out shaft 45 and the second winding shaft 47 provided in the second cartridge mounting portion 7. The front side paying-out boss 237 projects from the inner surface of the front side wall portion 233 toward the back side in the mounting direction and is engaged with the end portion of the second paying-out core 205 on the front side in the mounting direction. An end portion of the second winding core 207 on the front side in the mounting direction is engaged with the front side winding opening 239.

The first peripheral wall portion 235 extends from the peripheral edge portion of the front side wall portion 233 to the back side in the mounting direction. The first peripheral wall portion 235 includes a front side first wall portion 241 located on the −X side, a front side second wall portion 243 located on the −Y side, a front side third wall portion 245 located on the +X side, and a front side fourth wall portion 247 located on the +Y side. The second ribbon exposing portion 221 for exposing the second ink ribbon 213 is provided at a position where the front side first wall portion 241 and the front side fourth wall portion 247 intersect. The first peripheral wall portion 235 is an example of the “peripheral wall portion” of the present invention.

As shown in FIGS. 5 to 7, a second peripheral wall recessed portion 249 is provided at a substantially middle portion of the front side second wall portion 243 in the X direction. The second peripheral wall recessed portion 249 is formed in a shape that is recessed in a substantially rectangular shape that is slightly longer in the X direction when viewed from the front side in the mounting direction. The second peripheral wall recessed portion 249 is recessed in the front side second wall portion 243 over the entire mounting direction.

A fourth peripheral wall recessed portion 251 is provided at the +X side end portion of the front side second wall portion 243. The fourth peripheral wall recessed portion 251 is formed in a shape that is recessed in a substantially rectangular shape that is longer in the X direction when viewed from the front side in the mounting direction. Similar to the second peripheral wall recessed portion 249, the fourth peripheral wall recessed portion 251 is recessed in the front side second wall portion 243 over substantially the entire mounting direction. In the +X side region of the front side second wall portion 243, a substrate removal preventing portion 253 is provided on the end surface on the back side in the mounting direction so as to project toward the back side in the mounting direction. The substrate removal preventing portion 253 keeps the circuit substrate 311 attached to a substrate attaching portion 309 provided at the back side case 229 in a removal prevention state from the substrate attaching portion 309.

In the front side second wall portion 243, a first flat portion 255 located on the −X side of the second peripheral wall recessed portion 249 is substantially flush to a second flat portion 257 located between the second peripheral wall recessed portion 249 and the fourth peripheral wall recessed portion 251. If the second flat portion 257 is not provided, and the second peripheral wall recessed portion 249 and the fourth peripheral wall recessed portion 251 are connected to each other, the fourth peripheral wall recessed portion 251 located on the side of the center of gravity of the ribbon cartridge 200 may come into contact with the mounting surface, and the first flat portion 255 may be obliquely floated with respect to the mounting surface when the ribbon cartridge 200 is placed on the mounting surface such as a desk with the front side second wall portion 243 facing downward. In this case, the ribbon cartridge 200 is placed in a state in which it is easy to rattle the mounting surface. On the other hand, in the present embodiment, since the second flat portion 257 is provided, when the ribbon cartridge 200 is placed on the mounting surface with the front side second wall portion 243 facing downward, the second flat portion 257 abuts on the mounting surface. Therefore, the fourth peripheral wall recessed portion 251 is prevented from abutting on the mounting surface, and the first flat portion 255 is prevented from being in an obliquely floated state with respect to the mounting surface. Therefore, the ribbon cartridge 200 can be stably placed on the mounting surface.

As shown in FIGS. 5 and 6, a third peripheral wall recessed portion 259 is provided at the −Y side end portion of the front side third wall portion 245. The third peripheral wall recessed portion 259 is formed in a shape that is recessed in a substantially rectangular shape that is long in the Y direction when viewed from the front side in the mounting direction. The −Y side end portion of the third peripheral wall recessed portion 259 is connected with the +X side end portion of the fourth peripheral wall recessed portion 251. The third peripheral wall recessed portion 259 is formed in a shape that is recessed on the −Y side of the front side third wall portion 245, leaving the end portion on the back side in the mounting direction.

As shown in FIGS. 5, 6, and 8, the front side fourth wall portion 247 includes a front side first partial wall portion 261, a front side second partial wall portion 263, and a front side third partial wall portion 265. The front side first partial wall portion 261 extends from the +Y side end portion of the front side third wall portion 245 to the −X side. The front side second partial wall portion 263 is bent and extends from the −X side end portion of the front side first partial wall portion 261 in an oblique direction between the −X side and the −Y side. The front side third partial wall portion 265 is bent and extends from the −X side end portion of the front side second partial wall portion 263 at an angle closer to parallel to the X direction than the front side second partial wall portion 263.

The front side first partial wall portion 261 is provided with a first peripheral wall recessed portion 267. The first peripheral wall recessed portion 267 is formed in a shape that is recessed in a substantially trapezoidal shape that is long in the Y direction when viewed from the front side in the mounting direction. Similar to the third peripheral wall recessed portion 259, the front side fourth wall portion 247 of the first peripheral wall recessed portion 267 is recessed leaving the end portion on the back side in the mounting direction.

As shown in FIG. 9, the back side case 229 includes a back side wall portion 269 and a second peripheral wall portion 271. The back side wall portion 269 becomes the back side in the mounting direction when the ribbon cartridge 200 is mounted in the second cartridge mounting portion 7. The back side wall portion 269 faces the front side wall portion 233 of the front side case 227.

As shown in FIGS. 9 to 11, the back side wall portion 269 is provided with a back side paying-out opening 273, a back side winding opening 275, the paying-out side cylinder portion 277, the winding side cylinder portion 279, a first ribbon guide 281, a second ribbon guide 283, and a receiving insertion portion 285.

The back side paying-out opening 273 and the back side winding opening 275 are provided in the second ribbon core accommodating portion 217. The back side paying-out opening 273 and the back side winding opening 275 are respectively provided at positions corresponding to the second paying-out shaft 45 and the second winding shaft 47 provided in the second cartridge mounting portion 7. The back side paying-out opening 273 is engaged with the end portion of the second paying-out core 205 on the back side in the mounting direction. The back side winding opening 275 is engaged with the end portion of the second winding core 207 on the back side in the mounting direction. Hereinafter, the feeding direction of the second ink ribbon 213 is simply referred to as “feeding direction”. Further, in the feeding direction, the upstream side means the second paying-out core 205 side, and the downstream side means the second winding core 207 side.

The paying-out side cylinder portion 277 and the winding side cylinder portion 279 are located between the second ribbon core accommodating portion 217 and the second head insertion portion 219, and are provided so as to project from the back side wall portion 269 toward the front side in the mounting direction. The paying-out side cylinder portion 277 and the winding side cylinder portion 279 are respectively provided at positions corresponding to the first paying-out shaft 29 and the first winding shaft 31 provided in the overlapping region 21, and prevent the first paying-out shaft 29 and the first winding shaft 31 from interfering with the ribbon cartridge 200.

The paying-out side cylinder portion 277 is formed in a substantially cylindrical shape with a lid, and when the ribbon cartridge 200 is mounted in the second cartridge mounting portion 7, the first paying-out shaft 29 provided in the overlapping region 21 is inserted. As a result, when the ribbon cartridge 200 is mounted in the second cartridge mounting portion 7, the first paying-out shaft 29 is prevented from interfering with the ribbon cartridge 200. The paying-out side cylinder portion 277 is an example of the “paying-out shaft insertion portion” of the present invention. The paying-out side cylinder portion 277 has an inner diameter such that a gap is formed between the paying-out side cylinder portion 277 and the first paying-out rotation member 35 provided on the first paying-out shaft 29. Therefore, even if the first paying-out rotation member 35 rotates, the first paying-out rotation member 35 does not slide on the inner peripheral surface of the paying-out side cylinder portion 277. A press-fitting hole 287 into which a press-fitting pin (not shown) provided in the front side case 227 is press-fitted is provided on the front side of the paying-out side cylinder portion 277 in the mounting direction.

Further, the paying-out side cylinder portion 277 is located on the downstream side of the second paying-out core 205 in the feeding direction and guides the second ink ribbon 213 fed from the second paying-out core 205 to the second ribbon exposing portion 221. That is, the paying-out side cylinder portion 277 into which the first paying-out shaft 29 is inserted can also function as a guide member that guides the second ink ribbon 213. The paying-out side cylinder portion 277 may be configured by a cylinder portion provided in the front side case 227 and a cylinder portion provided in the back side case 229. However, in the present embodiment, the paying-out side cylinder portion 277 is provided only on one of the front side case 227 and the back side case 229, that is, only on the back side case 229. Therefore, it is possible to properly guide the second ink ribbon 213 without forming a step on the peripheral surface of the paying-out side cylinder portion 277. Further, the shape of the paying-out side cylinder portion 277 is not limited to the cylindrical shape, and may be, for example, an elliptic tubular shape, a semi-cylindrical shape, or a rectangular tubular shape.

The winding side cylinder portion 279 is formed in a substantially cylindrical shape, and when the ribbon cartridge 200 is mounted in the second cartridge mounting portion 7, the first winding shaft 31 provided in the overlapping region 21 is inserted. This prevents the first winding shaft 31 from interfering with the ribbon cartridge 200 when the ribbon cartridge 200 is mounted in the second cartridge mounting portion 7. The winding side cylinder portion 279 is an example of the “winding shaft insertion portion” of the present invention. The winding side cylinder portion 279 has an inner diameter such that a gap is formed between the winding side cylinder portion 279 and the first winding rotation member 37 provided on the first winding shaft 31. Therefore, even if the first winding rotation member 37 rotates, the first winding rotation member 37 does not slide on the inner peripheral surface of the winding side cylinder portion 279.

Further, the winding side cylinder portion 279 is located on the downstream side of the second ribbon exposing portion 221 in the feeding direction and guides the second ink ribbon 213 fed from the second ribbon exposing portion 221 to the second winding core 207. That is, the winding side cylinder portion 279 into which the first winding shaft 31 is inserted can also function as a guide member that guides the second ink ribbon 213. The winding side cylinder portion 279 may be configured by a cylinder portion provided on the front side case 227 and a cylinder portion provided on the back side case 229. However, in the present embodiment, the winding side cylinder portion 279 is provided only on one of the front side case 227 and the back side case 229, that is, only on the back side case 229. Therefore, it is possible to properly guide the second ink ribbon 213 without forming a step on the peripheral surface of the winding side cylinder portion 279. Further, the shape of the winding side cylinder portion 279 is, similar to the shape of the paying-out side cylinder portion 277, not limited to the cylindrical shape, and may be, for example, an elliptic tubular shape, a semi-cylindrical shape, or a rectangular tubular shape.

The first ribbon guide 281 guides the second ink ribbon 213 at a position on the downstream side of the winding side cylinder portion 279 in the feeding direction of the second ink ribbon 213. The first ribbon guide 281 is formed integrally with the back side wall portion 269. The first ribbon guide 281 includes a first guide main body 289 and two first guide ribs 291. The first guide main body 289 is formed in a substantially columnar shape, comes into contact with the ink surface 213a of the second ink ribbon 213, and guides the second ink ribbon 213. The two first guide ribs 291 project from the peripheral surface of the first guide main body 289 toward the +X side and the −Y side. The first guide rib 291 prevents the first guide main body 289 from tilting due to the pressure received from the second ink ribbon 213 fed in an appropriately stretched state.

The second ribbon guide 283 guides the second ink ribbon 213 at a position on the downstream side of the first ribbon guide 281 in the feeding direction. The second ribbon guide 283 is formed integrally with the back side wall portion 269. Similar to the first ribbon guide 281, the second ribbon guide 283 includes a second guide main body 293 and two second guide ribs 295. The second guide main body 293 is formed in a substantially columnar shape, comes into contact with the surface of the second ink ribbon 213 opposite to the ink surface 213a, and guides the second ink ribbon 213. The two second guide ribs 295 project from the peripheral surface of the second guide main body 293 toward the −X side and the +Y side. The second guide rib 295 prevents the second guide main body 293 from tilting due to the pressure received from the second ink ribbon 213.

The receiving insertion portion 285 is located at the +X side and −Y side corner of the back side wall portion 269 and is provided so as to project toward the front side in the mounting direction. The receiving insertion portion 285 is provided with the receiving insertion hole 297 penetrating in the mounting direction. The receiving portion 51 is inserted into the receiving insertion hole 297 when the ribbon cartridge 200 is mounted in the second cartridge mounting portion 7.

The second peripheral wall portion 271 extends from the peripheral edge portion of the back side wall portion 269 toward the front side in the mounting direction. The end surface of the second peripheral wall portion 271 on the front side in the mounting direction is in contact with the end surface of the first peripheral wall portion 235 of the front side case 227 on the back side in the mounting direction. The second peripheral wall portion 271 includes a back side first wall portion 299 located on the −X side, a back side second wall portion 301 located on the −Y side, a back side third wall portion 303 located on the +X side, and a back side fourth wall portion 305 located on the +Y side. The second ribbon exposing portion 221 is provided at a position where the back side first wall portion 299 and the back side fourth wall portion 305 intersect.

As shown in FIGS. 7 and 9 to 11, a back side peripheral wall recessed portion 307 is provided at the +X side end portion of the back side second wall portion 301 corresponding to the fourth peripheral wall recessed portion 251. Similar to the fourth peripheral wall recessed portion 251, the back side peripheral wall recessed portion 307 is formed in a shape that is recessed in a substantially rectangular shape that is long in the X direction when viewed from the front side in the mounting direction. The substrate attaching portion 309 is provided in the +X side and +Y side regions of the back side peripheral wall recessed portion 307. The circuit substrate 311 is attached to the substrate attaching portion 309. The circuit substrate 311 includes a storage element. Information such as the width of the second ink ribbon 213 and the remaining amount of the second ink ribbon 213 wound around the second paying-out core 205 is stored in the storage element. Further, since the substrate attaching portion 309 is provided in the +X side and +Y side regions of the back side peripheral wall recessed portion 307, the circuit substrate 311 attached to the substrate attaching portion 309 is prevented from abutting on the floor surface or the like even when the ribbon cartridge 200 is accidentally dropped, for example. This can prevent the circuit substrate 311 from being scratched or soiled.

A peripheral wall projecting portion 313 projecting from the end surface on the front side in the mounting direction toward the front side in the mounting direction is provided at a substantially middle portion of the back side second wall portion 301 in the X direction, that is, at a position corresponding to the second peripheral wall recessed portion 249. The peripheral wall projecting portion 313 is inserted into the second peripheral wall recessed portion 249 from the back side in the mounting direction.

As shown in FIGS. 8, 10, and 11, the back side fourth wall portion 305 includes a back side first partial wall portion 315, a back side second partial wall portion 317, and a back side third partial wall portion 319. The back side first partial wall portion 315 extends from the +Y side end portion of the back side third wall portion 303 to the −X side. The back side second partial wall portion 317 is bent and extends from the −X side end portion of the back side first partial wall portion 315 in an oblique direction between the −X side and the −Y side. The back side third partial wall portion 319 is bent and extends from the −X side end portion of the back side second partial wall portion 317 at an angle closer to parallel to the X direction than the back side second partial wall portion 317.

As shown in FIGS. 5 and 7 to 9, the second hook engaging portion 225 is provided at the back side second wall portion 301, the back side third wall portion 303, and the back side second partial wall portion 317. That is, the three second hook engaging portions 225 are provided on the peripheral edge portion of the second ribbon core accommodating portion 217 when viewed from the front side in the mounting direction. The second hook 49 is engaged with the second hook engaging portion 225 when the ribbon cartridge 200 is mounted in the second cartridge mounting portion 7. As a result, the ribbon cartridge 200 is prevented from being mounted in a state of floating from the bottom surface of the second cartridge mounting portion 7.

### [Grip Portion]

A grip portion 231 will be described with reference to FIGS. 5 and 6. The grip portion 231 is provided near the +X side of the front side case 227. This is because, as described above, the center of gravity is located near the +X side in the longitudinal direction of the ribbon cartridge 200, and therefore, when the ribbon cartridge 200 is attached to and detached from the second cartridge mounting portion 7, it is easier to attach and detach by gripping the ribbon cartridge 200 near the +X side. The +X side is an example of the “one side in the longitudinal direction of the second cartridge case” of the present invention. The grip portion 231 includes a first finger hook portion 321 provided on the +Y side and a second finger hook portion 323 provided on the −Y side. That is, the second finger hook portion 323 is provided on the opposite side of the first finger hook portion 321 with the second ribbon core accommodating portion 217 interposed therebetween when viewed from the front side in the mounting direction. As a result, the user can grip the ribbon cartridge 200 by interposing the second ribbon core accommodating portion 217 between the finger placed on the first finger hook portion 321 and the finger placed on the second finger hook portion 323.

The second finger hook portion 323 is provided with the second peripheral wall recessed portion 249 and the fourth peripheral wall recessed portion 251 described above. The user can place the right thumb on the second peripheral wall recessed portion 249 or the fourth peripheral wall recessed portion 251, for example. This makes it difficult for the finger to shake in the X direction with respect to the front side case 227. Further, as will be described later, the right middle finger, for example, can be placed on the front side first partial wall portion 261, and the right index finger, for example, can be placed on the front side second partial wall portion 263. With these, the ribbon cartridge 200 can be easily gripped.

The first finger hook portion 321 is provided with the front side first partial wall portion 261 and the front side second partial wall portion 263. Further, the first finger hook portion 321 also includes a bent portion connecting the front side second partial wall portion 263 and the front side third partial wall portion 265. The user can place the right middle finger, for example, on the front side first partial wall portion 261 and place the right index finger, for example, on the front side second partial wall portion 263. As described above, since the front side second partial wall portion 263 is bent and extends from the end portion of the front side first partial wall portion 261, the user can place two fingers on different surfaces. Further, the user may place a finger on the first peripheral wall recessed portion 267 provided at the front side first partial wall portion 261. This makes it difficult for the finger to shake in the X direction with respect to the front side case 227. As described above, the user can place the right thumb, for example, on the second peripheral wall recessed portion 249 or the fourth peripheral wall recessed portion 251. With these, the ribbon cartridge 200 can be more easily gripped.

When mounting the ribbon cartridge 200 in the second cartridge mounting portion 7, the user grips the grip portion 231 with his/her finger and further inserts the head cover 33 into the second head insertion portion 219 on the −X side. By pushing down the ribbon cartridge 200 in the mounting direction, it can be easily mounted. In other words, the user grips the grip portion 231 disposed near the center of gravity of the ribbon cartridge 200 and engages the head cover 33 and the second head insertion portion 219 to form a mounting guide, so that the ribbon cartridge 200 can be easily mounted in the second cartridge mounting portion 7. The −X side is an example of the “other side of the second cartridge case in the longitudinal direction” of the present invention. When the ribbon cartridge 200 is removed from the second cartridge mounting portion 7, the user can place an index finger, for example, at a bent portion connecting the front side second partial wall portion 263 and the front side third partial wall portion 265 and place a thumb, for example, at the facing second peripheral wall recessed portion 249. As a result, the user can easily grip the ribbon cartridge 200 and remove from the second cartridge mounting portion 7 without interfering with other structures of the tape printing device P or the tape guide 400 (see FIG. 2).

As described above, the ribbon cartridge 200 of the present embodiment includes the second winding core 207 and the winding side cylinder portion 279 into which the first winding shaft 31 is inserted when the ribbon cartridge 200 is mounted in the second cartridge mounting portion 7. Further, the ribbon cartridge 200 of the present embodiment includes the grip portion 231 including the first finger hook portion 321 and the second finger hook portion 323, which are provided so as to interpose the second ribbon core accommodating portion 217 therebetween.

According to this configuration, since the ribbon cartridge 200 is provided with the winding side cylinder portion 279, the interference of the first winding shaft 31 with the ribbon cartridge 200 when the ribbon cartridge 200 is mounted in the second cartridge mounting portion 7 is suppressed. Further, by gripping the grip portion 231 disposed near the center of gravity of the ribbon cartridge 200, the ribbon cartridge 200 can be easily attached to and detached from the second cartridge mounting portion 7. As a result, the ribbon cartridge 200 can be properly mounted in the second cartridge mounting portion 7. In other words, with respect to the tape printing device P that uses the space in which the first winding shaft 31 for rotating the first winding core 107 accommodated in the tape cartridge 100 is provided as the space in which the ribbon cartridge 200 is mounted, the ribbon cartridge 200 can be properly attached and detached.

### Modification Example

It is needless to say that the present invention is not limited to the above embodiment and various configurations can be adopted without departing from the spirit of the present invention. For example, the above embodiment can be modified into the following forms in addition to the above.

A modification example of the front side second partial wall portion 263 provided in the ribbon cartridge 200 will be described with reference to FIGS. 12 and 13. The front side second partial wall portion 263 is not limited to the configuration in which the front side second partial wall portion 263 is bent and extends from the end portion of the front side first partial wall portion 261. For example, as shown in FIG. 12, a configuration of extending in a curved manner from the end portion of the front side first partial wall portion 261 may be adopted. Also in this configuration, the user can place two fingers on different surfaces, and the ribbon cartridge 200 can be easily gripped. Furthermore, as shown in FIG. 13, a configuration in which the front side second partial wall portion 263 extends substantially flush with the front side first partial wall portion 261, and further bends and extends toward the front side third partial wall portion 265 may be adopted.

Although not shown, the first finger hook portion 321 may be provided with a projection projecting from the front side first partial wall portion 261 or the front side second partial wall portion 263. Similarly, the second finger hook portion 323 may be provided with a projection projecting from the front side second wall portion 243. With this configuration, since the user can place his/her finger on the projection, the ribbon cartridge 200 can be easily gripped. In addition, a projection projecting from the front side wall portion 233 toward the front side in the mounting direction or a recessed portion recessed toward the back side in the mounting direction may be provided as a grip portion. Further, the first finger hook portion 321 may be provided with a region having a higher friction coefficient than other regions by subjecting the front side first partial wall portion 261 and the front side second partial wall portion 263 to surface processing. Similarly, the second finger hook portion 323 may be provided with a region having a higher friction coefficient than other regions by subjecting the front side second wall portion 243 to surface processing. This makes it difficult for the user's finger to slip on the second cartridge case 209, so that the ribbon cartridge 200 can be easily gripped.

The winding side cylinder portion 279 is an example of the “winding shaft insertion portion” of the present invention. However, when the ribbon cartridge 200 is mounted in the second cartridge mounting portion 7, the configuration of the “winding shaft insertion portion” is not limited to the tubular shape as long as the first winding shaft 31 is inserted. For example, the opening provided at the back side wall portion 269 may function as a “winding shaft insertion portion”. Similarly, the paying-out side cylinder portion 277 is an example of the “paying-out shaft insertion portion” of the present invention. However, when the ribbon cartridge 200 is mounted in the second cartridge mounting portion 7, the configuration of the “paying-out shaft insertion portion” is not limited to the tubular shape as long as the first paying-out shaft 29 is inserted. For example, the opening provided at the back side wall portion 269 may function as a “paying-out shaft insertion portion”.

Although the grip portion 231 is provided on the front side case 227, it may be hooked on the back side case 229. For example, the back side first partial wall portion 315, the back side second partial wall portion 317, and the back side third partial wall portion 319 may be the first finger hook portion 321, or the bent portion connecting the back side second partial wall portion 317 and the back side third partial wall portion 319 may be the first finger hook portion 321. As described above, there are a plurality of types of the second cartridge case 209 having different thicknesses depending on the width of the accommodated second ink ribbon 213. In particular, in the second cartridge case 209 having a small thickness, the user can also grip the back side case 229 to mount it in the second cartridge mounting portion 7.

The “first ribbon cartridge” of the present invention is not limited to the configuration in which the print medium such as the first tape 111 is accommodated like the tape cartridge 100 of the present embodiment, and a configuration in which the print medium is not accommodated may be adopted. Similarly, the “second ribbon cartridge” of the present invention is not limited to the configuration in which the print medium is accommodated like the ribbon cartridge 200 of the present embodiment, and a configuration in which the print medium is accommodated may be adopted.

The tape printing device P may not have the first paying-out shaft 29. In this case, the ribbon cartridge 200 may not include the paying-out side cylinder portion 277. Further, the tape printing device P may not include the second paying-out shaft 45.

The printing device in which the ribbon cartridge 200 is mounted is not limited to a configuration that preforms printing on a tape-shaped print medium such as the first tape 111 and the second tape 500. That is, the “printing device” of the present invention may be, for example, a device that performs printing on roll paper or sheets.

### REFERENCE SIGNS LIST

200 ribbon cartridge
205 second paying-out core
207 second winding core
213 second ink ribbon
217 second ribbon core accommodating portion
219 second head insertion portion
221 second ribbon exposing portion
231 grip portion
233 front side wall portion
235 first peripheral wall portion
237 front side paying-out boss
239 front side winding opening
241 front side first wall portion
243 front side second wall portion
245 front side third wall portion
247 front side fourth wall portion
249 second peripheral wall recessed portion
251 fourth peripheral wall recessed portion
255 first flat portion
257 second flat portion
259 third peripheral wall recessed portion
261 front side first partial wall portion
263 front side second partial wall portion
265 front side third partial wall portion
267 first peripheral wall recessed portion
277 paying-out side cylinder portion
279 winding side cylinder portion
341 first pressing portion
343 second pressing portion
345 third pressing portion
349 feeding side virtual line
351 winding side virtual line

1. A ribbon cartridge that is a second ribbon cartridge to be mounted in a printing device including
a first cartridge mounting portion in which a first ribbon cartridge accommodating a first winding core around which a first ink ribbon is wound is mounted,
a second cartridge mounting portion in which the second ribbon cartridge accommodating a second winding core around which a second ink ribbon is wound is mounted,
a first winding shaft which is provided in an overlapping region of the first cartridge mounting portion and the second cartridge mounting portion and is inserted into the first winding core when the first ribbon cartridge is mounted in the first cartridge mounting portion, and
a second winding shaft, which is provided in a second non-overlapping region out of the overlapping region in the second cartridge mounting portion and is inserted into the second winding core when the second ribbon cartridge is mounted in the second cartridge mounting portion,
the ribbon cartridge comprising:
a second paying-out core around which the second ink ribbon is wound; and
a second cartridge case having a second ribbon core accommodating portion accommodating the second paying-out core and the second winding core, wherein
a print head and a head cover that covers the print head are provided in the overlapping region,
the second ribbon core accommodating portion is provided near one side of the second cartridge case in a longitudinal direction, and
in the second cartridge case, a head insertion portion into which the head cover is inserted is provided on the other side of the second cartridge case in the longitudinal direction, which is an opposite side to the one side and a grip portion for gripping the second cartridge case is provided near the one side when the second ribbon cartridge is mounted in the second cartridge mounting portion.

2. The ribbon cartridge according to claim 1, wherein
the grip portion has a first finger hook portion and a second finger hook portion provided on an opposite side to the first finger hook portion while interposing the second ribbon core accommodating portion between the first finger hook portion and the second finger hook portion when viewed from a front side in a mounting direction of the second ribbon cartridge.

3. The ribbon cartridge according to claim 2, wherein
the second cartridge case has a front side wall portion on the front side in the mounting direction and a peripheral wall portion extending from a peripheral edge portion of the front side wall portion to a back side in the mounting direction, and
at least one of the first finger hook portion and the second finger hook portion is provided with a front side first partial wall portion that is a part of the peripheral wall portion and a front side second partial wall portion that is a part of the peripheral wall portion and that is bent or curved and extends from an end portion of the front side first partial wall portion.

4. The ribbon cartridge according to claim 2, wherein
the second cartridge case has a front side wall portion on the front side in the mounting direction and a peripheral wall portion extending from a peripheral edge portion of the front side wall portion to a back side in the mounting direction, and
at least one of the first finger hook portion and the second finger hook portion is provided with a peripheral wall recessed portion in which the peripheral wall portion is recessed.

5. The ribbon cartridge according to claim 2, wherein
the second cartridge case has a front side wall portion on the front side in the mounting direction and a peripheral wall portion extending from a peripheral edge portion of the front side wall portion to a back side in the mounting direction,
one of the first finger hook portion and the second finger hook portion is provided with a front side first partial wall portion that is a part of the peripheral wall portion and a front side second partial wall portion that is a part of the peripheral wall portion and that is bent or curved and extends from an end portion of the front side first partial wall portion, and
a peripheral wall recessed portion in which the peripheral wall portion is recessed is provided at the other of the first finger hook portion and the second finger hook portion.

6. The ribbon cartridge according to claim 3, wherein
a front side third partial wall portion that is a part of the peripheral wall portion and is bent and extends from an end portion of the front side second partial wall portion to the other side of the second cartridge case in the longitudinal direction is further provided.

7. The ribbon cartridge according to claim 5, wherein
a front side third partial wall portion that is a part of the peripheral wall portion and is bent and extends from an end portion of the front side second partial wall portion to the other side of the second cartridge case in the longitudinal direction is further provided.
